(19) United States
(12) Patent Application Publication
(10) Pub. No.: US 2013/0141908 A1
(43) Pub. Date: Jun. 6, 2013

(54) MINIATURE CELLULAR STRUCTURE FOR RETROFIT LED LAMP SECONDARY OPTICS

(71) Applicants: Edward Rodriguez, Wakefield, MA (US); James Leahy, Old Greenwich, CT (US)

(72) Inventors: Edward Rodriguez, Wakefield, MA (US); James Leahy, Old Greenwich, CT (US)

(21) Appl. No.: 13/641,365

(22) PCT Filed: Apr. 15, 2011
(86) PCT No.: PCT/US11/32711

§ 371 Date: Feb. 25, 2013

Related U.S. Application Data
(60) Provisional application No. 61/325,134, filed on Apr. 16, 2010.

(51) Int. Cl. F21V 5/04; F21V 5/00

(52) U.S. Cl. CPC F21V 5/04; F21V 5/007
USPC 362/240; 362/311.02

(57) ABSTRACT

In one general aspect, an LED-based illumination source is disclosed that includes a screw-in household base with an outer thread centered about an insertion axis. A directional-type illumination housing is mechanically connected to the base and has a round light delivery end centered around the insertion axis and has a diameter that is larger than the base. One or more LED illumination elements occupy a portion of the round light delivery end of the directional-type illumination housing and each has an optical axis at least generally parallel with the insertion axis and face away from the base. One or more at least generally coplanar lenses have at least generally parallel optical axes each being aligned with one of the elements and being positioned opposite from the base with respect to the elements. A planar light-spreading element is positioned at least generally perpendicular to the optical axes and spans a portion of the round light delivery end of the directional-type illumination housing different from the portion of the round light delivery end of the directional-type illumination housing occupied by the illumination elements. The planar light-spreading element is optically coupled to the illumination elements, with the planar light-spreading element including an at least generally planar light-transmitting surface facing toward the base and with the planar light-transmitting surface defining lens elements each having an optical axis that is generally perpendicular to the light-transmitting surface.

### CROSS-REFERENCE TO RELATED APPLICATIONS

This application claims the benefit under 35 U.S.C. 119(e) of U.S. provisional application Ser. No. 61/325,134 entitled MINIATURE CELLULAR STRUCTURE FOR RETROFIT LED LAMP SECONDARY OPTICS, filed Apr. 16, 2010, which is herein incorporated by reference. This application is further related to U.S. design Pat. No. D636904 and U.S. design application No. 29/359,944, both entitled LED LAMP, and to U.S. design Pat. Nos. D636905 and D636905, both entitled LED LAMP FACE. All of these design patents and applications are herein incorporated by reference.

### BACKGROUND

There is considerable attention being given to the use of high-brightness LED (HBLED) technology as a light source to replace traditional incandescent lamps. The catalyst for introduction of white LEDs, first as indicators, and later for commercial illumination sources, has been supported by the development and refinement of blue-LED material-science processes, in conjunction with appropriate yellow-phosphor coatings for creating what is termed secondary emission. The science of secondary emission has been long understood by those skilled in lighting technology and has previously provided the basis for fluorescent lamps.

In lamps that use secondary emission, monochromatic light, generated within a phosphor-coated LED chip, causes the phosphor to emit light of different wavelengths. This has resulted in white HBLEDs, with rating of up to a few watts and lumen outputs that can exceed 90-100 lumens per watt, depending on color temperature.

The mechanism used in these lamps is much like that used for the gaseous discharge of a fluorescent lamp tube where ultraviolet light excites the phosphor coating on the inside of an evacuated glass tube to create visible white light. Interestingly, many of the difficulties in refining the technology of white LEDs relate to the same issues experienced with gaseous discharge lamps in mastering phosphor composition and deposition processes to achieve consistency and desired performance.

The fundamentals of incandescent lamp design have changed little in the last 75 years. Similarly, the design and performance of fluorescent lamps have not changed substantially in the last 40 years. That is to say, both incandescent and fluorescent lamp processes are considered to be mature technologies, with very little gain in efficacy (i.e. lumens per watt) expected in the near future.

High brightness LED's, on the other hand, are experiencing gains in efficacy as scientists refine techniques for light extraction from LED chips and slowly master the composition and deposition of phosphors. When many of these factors are better understood in the future, and efficacy is further improved (a projection accepted by most industry experts) LED lamps are expected to be far more easily accepted and many of the present challenges should be mitigated. Until that happens, however, there are compelling reasons to develop novel techniques to enhance what now exists so as to accelerate commercial viability.

Two factors are driving the substantial interest in white-emitting HBLEDs as a candidate to replace incandescent lamps in a large number of general illumination applications: longevity and energy conservation

The typical white HBLED chip, generally rated from one to three watts, if used properly, is expected to have a useful operating life of over 50,000 hours. This is dramatically longer than the 750-2,000 hours of a typical incandescent lamp, and is much longer than the typical 6,000 hours of a compact fluorescent lamp. Readily available HBLEDs can exhibit efficacies of more than 90 lumens per watt, which is 6-10 times better than either a regular or quartz-halogen version of an incandescent lamp.

While there can be significant saving in bulb replacement expenses over a number of years, it is the saving in electricity costs which can present the most significant benefit. In conditions of near-continual operation, such as in restaurants, hotels, stores, museums, or other commercial installations, the electricity savings can provide a very favorable return on investment, even with relatively high purchase prices, in 18-24 months. The potential for rapid payback is believed to be much more evident than for other highly publicized “green” technologies” such as hybrid vehicles, wind turbines, solar power etc.

There is widespread acceptance that white-light LED sources are attractive as possible incandescent replacement lamps, especially in those types where the LED lamp is at its best, namely as reflector-type lamps such as PAR 30, PAR 38, or MR16. LEDs are by their nature directional light sources in that their light is emitted typically in a conical 120-150 degree beam angle, whereas an incandescent lamp tends to radiate in a near 360-degree spherical pattern and generally uses loss-inducing reflectors to direct light. Compact fluorescent lamps can be very inefficient when used as directional light sources, because they tend to be very difficult to collimate.

The LED lamp starts out in a better position in spot or flood lamp applications because of its inherent directionality. In fixtures for ceiling down-lighting, outside security, or retail merchandise highlighting, the need is for directional lighting, a factor taking advantage of the LED lamp's inherent emission characteristics. Those with a reasonable knowledge of physics know that a point source of light is best for use with a reflector or collimator. A CFL, being the virtual opposite of a point source, tends to be poor in this respect. An incandescent filament is much smaller but still generally needs a good-sized reflector. An LED chip, being typically no larger than a millimeter on a side, lends itself to many more options with much smaller reflectors and collimating lenses.

Consequently, while white HBLEDs may alone, or as a partner with the compact fluorescent lamp (CFL), replace incandescent filament lamps, it is in the reflector lamps where the performance and economics of white LEDs appear likely to have the more immediate impact. While the CFL has become widely commercialized, the LED lamp does have certain advantages, which over the long term could give it a substantial marketing edge. Specifically, compared to a CFL, the LED lamp tends to be a) more compatible with standard lamp dimming methodologies, b) easier to operate in low temperature environments, c) mercury-free, d) able to retain its efficacy when dimmed, e) essentially immune to shock and vibration, and f) immune to the degradation which CFL's can experience with repetitive on/off cycling.

Even with the apparent advantages of the white HBLED lamp and its assumed inevitability as a commercially successful product category, there has yet to be an acknowledged product-leadership candidate; that is, a product which meets the performance and cost criteria necessary for early-adopter, sophisticated, commercial users to accept it on a large scale.

### SUMMARY

In a high-power (above 3-4 watts) LED reflector-type lamp such as those known as PAR lamps, which are intended for general illumination, it is a common practice to employ multiple LEDs in order to achieve the desired brightness. For example, while an individual LED may be rated for a maximum of 2-3 watts, it can often be determined that well over 10 watts is needed to achieve the necessary total light output. This might require, 3, 5, 7, 9 or many more LEDs arranged in some type of circular, triangular, hexagonal or other similarly reasonably symmetrical pattern.

Secondary optics are generally placed over individual LEDs to collimate or focus the light from each LED into a narrower beam, and a group of lenses combines all the resulting beams into a single narrow beam. Typically, such lamps might have beam angles from 10 to 45 degrees. The popular screw-in spot light found in homes, businesses, restaurants, etc, is an example of such lamps, and it has historically used an incandescent filament. It should be noted that a halogen lamp is simply a variant of a conventional incandescent lamp with tungsten filament. For the purpose of this discussion, a distinction between halogen or incandescent is of no significance.

There are an increasing number of lamps that employ LEDs, which are often referred to as “retrofit” lamps, and are intended to serve the same basic purpose as their filament-based counterparts while making use of their increased electricity efficiency and the long life of LED technology. Those skilled in the art are familiar with all the basic differences between LED and filament sources of light and for simplicity those differences will not be described here.

Suffice it to say that an incandescent filament is considered a point source of light, enabling it to be focused by a single reflector or lens. If, after focusing by the reflector, the light passes through a glass lamp cover, as in a common PAR 30 spot light, and that glass cover has a slight texture to it, the light can still be focused as a spot light but a viewer of the lamp will see a light source, brighter at its center, but the entire lamp surface will also appear illuminated. In other words, from a distance, the lamp looks like a relatively smooth disc of light 3.75″ in diameter.

When multiple LEDs are used to create a collimated-beam lamp of substantial total light output, the light does not come from a point source of light but instead from many point sources of light, each typically needing its own collimating lens.

With a multiplicity of collimating lenses, and each lens typically being between 0.40″ and 1.0″ diameter, light illuminates a distant surface in an identical manner as the filament spot light, but from a distance a viewer will typically observe numerous discs of light, as though there were 3, 5, 7, 9 or more flashlights or individual bulbs, arranged in a cluster, all aiming at the viewer. This effect is known as pixelation of the light source. In other words, the light source, instead of being a continuous lighted surface as in a filament lamp, is made up of pixels (i.e individual light source elements with unlighted areas in between or around them).

It is generally thought in the lighting industry that “pixilation” in a light source is undesirable in that it runs counter to what traditional lamp users expect when employing lamps in places where aesthetics play any part. If they were to have such a spot or flood lamp screwed into a kitchen-ceiling down-light fixture, they would expect to see a smooth round, disc-like source of light, rather than many small dots or circles of light.

It is known to place a clear plastic or glass cover with a diffusion pattern, like a frosted surface, over an entire multi-LED lens array. This can soften the appearance so that the individuality of the light sources becomes far less evident. This type of approach is also taken with popular office fluorescent ceiling fixtures where the fixtures might, for example, have four 40-watt, 4-foot long tubes. Typically there is a clear plastic “diffuser” panel attached to the bottom of the fixture so that the viewer sees a 2′ by 4′ area of relatively smooth light and the fluorescent tube light source are not particularly noticeable.

This approach can be taken with such fluorescent fixtures because there is generally no objective to focus the light. But putting a diffusing or softening cover over LED secondary optics lenses tends to widen the beam angle for those lenses, and the beam angle specification may no longer be held. In other words, it is generally not workable to attempt narrow-beam-angle focusing of a cluster of high brightness LEDs while covering them with a single, clear, diffusing element.

The challenge then is to maintain the beam-angle of the focusing lenses, while still achieving, in spite of the pixilated light sources, the homogeneous look of a filament spot light from a distance, as perceived by a viewer. Fortunately, the non linearity of the human eye's response to various light intensities permits the light-softening techniques used for collimated beam filament lamps to be achieved another way.

It also turns out that in virtually any LED lamp with secondary optics, usually clear plastic lenses known as TIR (total internal reflection) lenses, there is always some light which escapes and is not directed through the lens to the intended target area. This is generally regarded as “wasted” light.

If a good deal of the small amount of wasted light is directed to the circular surface area of the lamp not occupied by the diameters of the TIR focusing lenses themselves, and the surface of the non-lens area is appropriately patterned with “micro lenses,” all of the non-lens area can be back-lighted and the viewer can have the desired perception of “whiteness” in the non-lens areas. That is, the micro-lenses will receive much of the wasted/scattered light and direct it forward a viewer anywhere within a 180-degree beam angle.

Each micro lens can act much like the molded-in tiny hemispherical lenses employed in many fluorescent lamp ceiling-fixture diffusers. It has been noted that in a fluorescent fixture, the diffuser tends to preclude any attempt at collimation or focusing but in this case, with the LED lamp, collimation in the non lens area is not needed, and indeed it can be preferable for this light to be directed forward but in wide angles.

The result is that the emission surface of a lamp, which was totally illuminated in a filament lamp, but only has illuminated pixels in prior-art LED lamps, can now have a totally illuminated surface, with brighter areas where the lenses are. From a distance, or off at a side angle, the human eye then perceives the lamp as being very similar to that of a filament lamp in that there is significantly reduced evidence of pixilation.

In one general aspect, the invention features an LED-based illumination source that includes a screw-in household base with an outer thread centered about an insertion axis. A directional-type illumination housing is mechanically connected to the base and has a round light delivery end centered around the insertion axis and has a diameter that is larger than the base. A plurality of LED illumination elements occupy a portion of the round light delivery end of the directional-type illumination housing and each has an optical axis at least generally parallel with the insertion axis and face away from the base. A plurality of at least generally coplanar lenses have at least generally parallel optical axes each being aligned with one of the elements and being positioned opposite from the base with respect to the elements. A planar light-spreading element is positioned at least generally perpendicular to the optical axes and spans a portion of the round light delivery end of the directional-type illumination housing different from the portion of the round light delivery end of the directional-type illumination housing occupied by the illumination elements. The planar light-spreading element is optically coupled to the illumination elements, with the planar light-spreading element including an at least generally planar light-transmitting surface facing toward the base and with the planar light-transmitting surface defining lens elements each having an optical axis that is generally perpendicular to the light-transmitting surface.

In preferred embodiments the planar light-spreading element can be made of a transparent material. The planar light-spreading element can be made of a translucent material. The planar light-spreading element can include a plurality of light gathering protrusions extending toward the base to collect further transversely emitted light from the illumination elements. The protrusions can be tunnel-shaped protrusions that each surround one of the LED illumination elements. The protrusions can have a circular cross-section. The source can further including a light-transmissive cover positioned opposite the base with respect to the illumination elements to cover the plurality of coplanar lenses and the light-spreading element. The planar light-spreading element can span a portion of the round light delivery end of the directional-type illumination housing that mostly surrounds the portion of the round light delivery end of the directional-type illumination housing occupied by the illumination elements. The lens elements can each be defined by hemispherical portions of the planar light spreading element, such as by hemispherical portions of the underside of the planar light spreading element, facing the LED illumination elements. The lens elements can have diameters less than 20% of the lenses aligned with the LED illumination elements.

In another general aspect, the invention features LED-based illumination method that includes receiving light from a plurality of different LED illumination elements, separately focusing light received from each of the elements, receiving further light from the LED illumination elements, and spreading the further light around a lamp surface.

In preferred embodiments the step of receiving light can receive on-axis light from each of the LED illumination elements, with the step of receiving further light receiving off-axis light from at least some of the LED illumination elements. The step of receiving light can receive light at a first plurality of lenses and the step of receiving further light can receive light at a second plurality of lenses that are each smaller than the lenses in the first plurality of lenses.

In a further general aspect, the invention features an LED-based illumination source that includes means for receiving light from a plurality of different LED illumination elements, means for separately focusing light received from each of the LED illumination elements, means for receiving further light from the LED illumination elements, and means for spreading the further light around a lamp surface.

In a further general aspect, the invention features an LED-based illumination source that includes a screw-in household base with an outer thread centered about an insertion axis. A directional-type illumination housing is mechanically connected to the base and has a round light delivery end centered around the insertion axis and has a diameter that is larger than the base. An LED illumination element occupies a portion of the round light delivery end of the directional-type illumination housing and has an optical axis at least generally parallel with the insertion axis and face away from the base. A lens is aligned with one of the elements and is positioned opposite from the base with respect to the element. A planar light-spreading element is positioned at least generally perpendicular to the optical axis and spans a portion of the round light delivery end of the directional-type illumination housing different from the portion of the round light delivery end of the directional-type illumination housing occupied by the illumination element. The planar light-spreading element is optically coupled to the illumination element, with the planar light-spreading element including an at least generally planar light-transmitting surface facing toward the base and with the planar light-transmitting surface defining lens elements each having an optical axis that is generally perpendicular to the light-transmitting surface.

### DESCRIPTION OF THE FIGURES

FIGS. 1A-D show two isometric views, one front view, and one side view of a retrofit LED PAR lamp having integral multiple lenses.

FIGS. 2A-B show two cross sections of the lamp of FIG. 1.

FIG. 3 shows an enlarged cross section view of the FIG. 2 micro lens surface.

FIG. 4 shows light emission without micro lenses.

FIG. 5 shows light emission with micro lenses.

### DESCRIPTION OF AN ILLUSTRATIVE EMBODIMENT

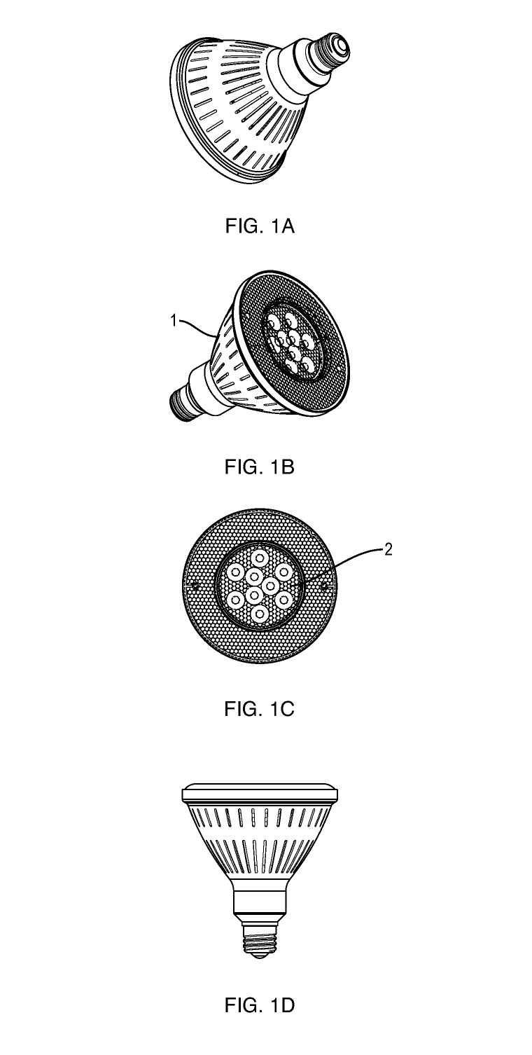

FIG. 1 shows a retrofit PAR-style lamp 1 and its top light emitting surface 2.

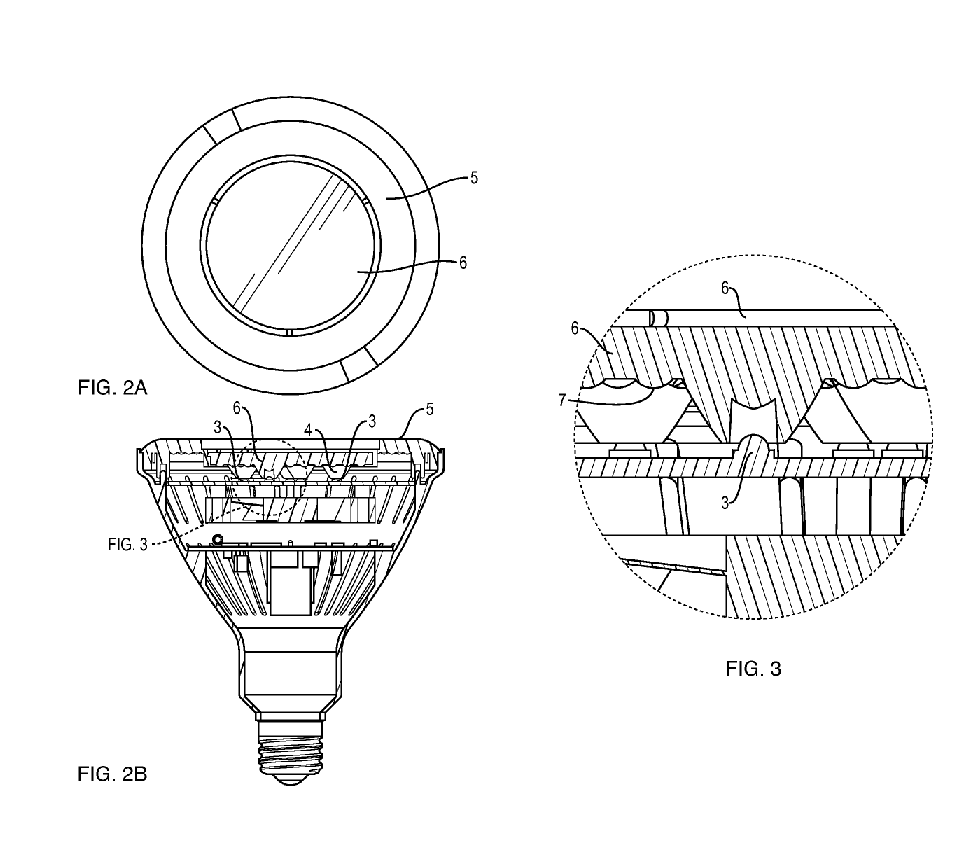

FIG. 2 shows a profile view in which can be seen one of a series of a surface-mounted high-brightness LEDs 3. Positioned over each LED is placed a collimated lens 4 which may be an individual lens or part of a single molded plastic with multiple integral lenses. In this representation there are nine LEDs and nine lenses but there is no requirement for any specific number. FIG. 3 shows an enlarged profile where a cross section of the micro lens 7 can be more easily seen

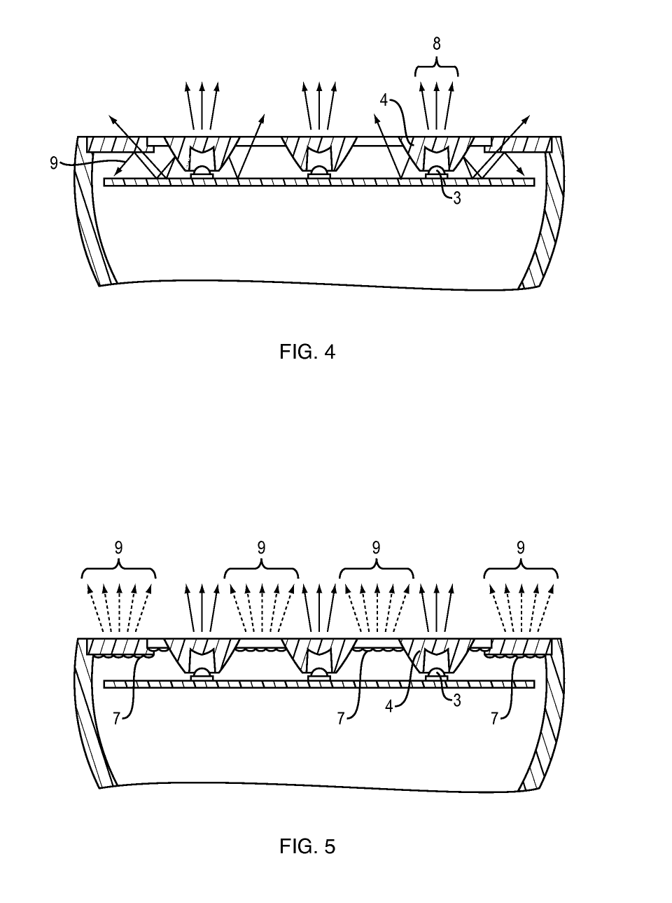

FIGS. 4 and 5 show simplified cross-sections and micro lenses in a donut-shaped clear plastic lamp cover 5 and a clear plastic lens array disc 6 in which the individual lenses 4 reside. Also shown are the principal collimated light beams 8 exiting the lenses 3. In FIG. 5, if the donut shaped portion were metal, or opaque plastic, as in many prior art lamps, the only light emission would be from the lenses and pixelation would be most obvious. Stray light either is reflected back into the LED cavity area or passes directly out though clear portion of the lens disc or lamp cover. If any portion of the lens disc or lamp cover donut is clear smooth plastic, it simply becomes a transparent window. There is no perception of backlighting.

If the lamp cover donut as well as the plastic areas between the lens circles have micro lens hemispheres 7 on the underside as in the described embodiment, those micro lenses will redirect stray light. Those areas will no longer be perceived as transparent but rather as back-lighted, glowing surfaces. That effect will in turn make the brightness of the lenses themselves appear less pronounced (i.e., less contrast with the surrounding lamp cover donut or with the inter-lens spaces) as seen by a viewer at a distance, thereby making the lamp more aesthetically appealing. In other words, the described arrangement can ensure that 100% of the lamp surface holding the lenses is neither transparent nor partially opaque to a viewer and is perceived as being totally illuminated.

Those skilled in the art know that similar back lighting effects could be achieved by simply sandblasting the plastic molding tooling surface so as to create a frosted surface effect in the non lens area, as has been done in other lighting-related products. Indeed, this could have been done with traditional diffuser panels for office ceiling fluorescent fixtures. However it is known to those skilled in such designs that frosted surfaces will create the desired diffusion effects but at significant loss of through-transmission of light due to excessive back scatter. Controlled-dimension micro lenses do not cause any meaningful degree of this type of back scatter but rather create the desired diffusion effect by directing a substantial amount light in the desired direction toward the viewer.

In a fluorescent ceiling panel, virtually all of the light is directed through such miniature lenses in the diffuser so that the delivered light is close in transmittance to that of a completely transparent sheet of plastic. In the case of the described embodiment, such a degree of transmittance of the stray light is important but not to the same degree as in a fluorescent fixture.

The principal criterion is that there is a result of substantial backlighting. By optimizing the diameter and height of the hemisphere-like micro lenses, it is possible to achieve the desired smooth backlighting effect as perceived, from just a short distance from the lamp, using a tiny amount of light which otherwise would have been lost as an inevitable byproduct of such an LED lamp optical system. In a typical embodiment, the micro lenses have diameters typically less than 20% that of the main collimating lenses and employ a simple plano-convex structure rather than the TIR structure of the main lenses.

The present invention has now been described in connection with a number of specific embodiments thereof. In one general aspect, the invention can provide a subminiature, secondary-optic cellular structure that can minimize the undesirable pixel effect commonly observed in certain retrofit reflector lamps, employing multiple LEDs as the light source, by back lighting all translucent surfaces which are separate from, but in the same plane as, the principal light-emitting lens surfaces. However, numerous modifications which are contemplated as falling within the scope of the present invention should now be apparent to those skilled in the art. For example, the micro lenses can be integral to either side of a light spreading element or they can be built in a separate part. Therefore, it is intended that the scope of the present invention be limited only by the scope of the claims appended hereto. In addition, the order of presentation of the claims should not be construed to limit the scope of any particular term in the claims.

What is claimed is:

1. An LED-based illumination source, comprising:
a screw-in household base with an outer thread centered about an insertion axis,
a directional-type illumination housing mechanically connected to the screw-in base and having a round light delivery end centered around the insertion axis of the screw-in household base and having a diameter that is larger than a diameter of the screw-in base,
a plurality of LED illumination elements occupying a portion of the round light delivery end of the directional-type illumination housing and each having an optical axis at least generally parallel with the insertion axis of the screw-in household base and facing away from the screw-in household base,
a plurality of at least generally coplanar lenses having at least generally parallel optical axes each being aligned with one of the LED illumination elements and being positioned opposite from the screw-in household base with respect to the LED illumination elements, and
a planar light-spreading element positioned at least generally perpendicular to the optical axes and spanning a portion of the round light delivery end of the directional-type illumination housing different from the portion of the round light delivery end of the directional-type illumination housing occupied by the plurality of LED illumination elements, wherein the planar light-spreading element is optically coupled to the LED Illumination elements, wherein the planar light-spreading element includes a light-transmitting surface facing toward the screw-in household base and wherein the light-transmitting surface of the light-spreading element defines a plurality of lens elements each having an optical axis that is generally perpendicular to the light-transmitting surface.

2. The apparatus of claim 1 wherein the planar light-spreading element is made of a transparent material.

3. The apparatus of claim 1 wherein the planar light-spreading element is made of a translucent material.

4. The apparatus of claim 1 wherein the planar light-spreading element includes a plurality of light gathering protrusions extending toward the screw-in household base to collect further transversely emitted light from the LED illumination elements.

5. The apparatus of claim 4 wherein the protrusions are tunnel-shaped protrusions that each surround one of the LED illumination elements.

6. The apparatus of claim 5 wherein the protrusions have a circular cross-section.

7. The apparatus of claim 1 further including a light-transmissive cover positioned opposite the screw-in household base with respect to the LED illumination elements to cover the plurality of coplanar lenses and the light-spreading element.

8. The apparatus of claim 1 wherein the planar light-spreading element spans a portion of the round light delivery end of the directional-type illumination housing that mostly surrounds the portion of the round light delivery end of the directional-type illumination housing occupied by the plurality of LED illumination elements.

9. The apparatus of claim 1 wherein the light-transmitting surface of the light-spreading element is at least generally planar.

10. The apparatus of claim 1 wherein the lens elements are each defined by hemispherical portions of the planar light spreading element.

11. The apparatus of claim 1 wherein the lens elements are each defined by hemispherical portions of the underside of the planar light spreading element, facing the LED illumination elements.

12. The apparatus of claim 1 wherein the lens elements have diameters less than 20% of the lenses aligned with the LED illumination elements.

13. An LED-based illumination method, comprising:
receiving light from a plurality of different LED illumination elements,
separately focusing light received from each of the LED illumination elements,
receiving further light from the LED illumination elements, and
spreading the further light around a lamp surface.

14. The method of claim 13 wherein the step of receiving light receives on-axis light from each of the LED illumination elements, and wherein the step of receiving further light receives off-axis light from at least some of the LED illumination elements.

15. The method of claim 13 wherein the step of receiving light receives light at a first plurality of lenses and the step of receiving further light receives light at a second plurality of lenses that are each smaller than the lenses in the first plurality of lenses.

16. An LED-based illumination source, comprising:
means for receiving light from a plurality of different LED illumination elements,
means for separately focusing light received from each of the LED illumination elements,
means for receiving further light from the LED illumination elements, and
means for spreading the further light around a lamp surface.

17. An LED-based illumination source, comprising:
a screw-in household base with an outer thread centered about an insertion axis,
a directional-type illumination housing mechanically connected to the screw-in base and having a round light delivery end centered around the insertion axis of the screw-in household base and having a diameter that is larger than a diameter of the screw-in base,
an LED illumination element occupying a portion of the round light delivery end of the directional-type illumination housing and having an optical axis at least generally parallel with the insertion axis of the screw-in household base and facing away from the screw-in household base,
a lens aligned with the LED illumination elements and being positioned opposite from the screw-in household base with respect to the LED illumination element, and
a planar light-spreading element positioned at least generally perpendicular to the optical axes and spanning a portion of the round light delivery end of the directional-type illumination housing different from the portion of the round light delivery end of the directional-type illumination housing occupied by the LED illumination element, wherein the planar light-spreading element is optically coupled to the LED Illumination element, wherein the planar light-spreading element includes a light-transmitting surface facing toward the screw-in household base and wherein the light-transmitting surface of the light-spreading element defines a plurality of lens elements each having an optical axis that is generally perpendicular to the light-transmitting surface.

18. The apparatus of claim 17 wherein the planar light-spreading element is made of a transparent material.

19. The apparatus of claim 17 wherein the planar light-spreading element is made of a translucent material.

20. The apparatus of claim 17 wherein the planar light-spreading element includes a light gathering protrusion extending toward the screw-in household base to collect further transversely emitted light from the LED illumination element.

21. The apparatus of claim 20 wherein the protrusion is a tunnel-shaped protrusion that surrounds the LED illumination element.

22. The apparatus of claim 21 wherein the protrusion has a circular cross-section.

23. The apparatus of claim 17 further including a light-transmissive cover positioned opposite the screw-in household base with respect to the LED illumination element to cover the lens and the light-spreading element.

24. The apparatus of claim 17 wherein the planar light-spreading element spans a portion of the round light delivery end of the directional-type illumination housing that mostly surrounds the portion of the round light delivery end of the directional-type illumination housing occupied by the LED illumination element.

25. The apparatus of claim 17 wherein the light-transmitting surface of the light-spreading element is at least generally planar.

26. The apparatus of claim 17 wherein the lens elements are each defined by hemispherical portions of the planar light spreading element.

27. The apparatus of claim 17 wherein the lens elements are each defined by hemispherical portions of the underside of the planar light spreading element, facing the LED illumination element.

28. The apparatus of claim 17 wherein the lens elements have diameters less than 20% of the lens aligned with the LED illumination element.
